(19) United States
(12) Patent Application Publication
(10) Pub. No.: US 2009/0195911 A1
(43) Pub. Date: Aug. 6, 2009

(54) MAGNETIC RECORDING DEVICE

(75) Inventors: Motomichi Shibano, Kawasaki (JP); Masaya Ohtake, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/247,629

(22) Filed: Oct. 8, 2008

(30) Foreign Application Priority Data
Jan. 31, 2008 (JP) 2008-021309

(51) Int. Cl. G11B 21/02; G11B 5/127

(52) U.S. Cl. 360/75; 360/110; 360/51; G9B/5.04; G9B/20

(57) ABSTRACT

A magnetic recording device includes a patterned media magnetic recording medium where multiple tracks are arranged for radial direction in a concentric manner, the tracks each being formed by arranging multiple recording dots. The recording dots are each made of an isolated magnetic material and arranged in a rotational direction. The magnetic recording device further includes a magnetic head. The magnetic head includes: a main magnetic pole that faces the magnetic recording medium; a magnetic field generation coil that generates magnetic field to be transmitted to the magnetic recording medium through the main magnetic pole; a return yoke that receives the magnetic flux transmitted to the magnetic recording medium from the main magnetic pole and returns the magnetic flux thus received to the magnetic field generation coil; and a search coil that detects a change in magnetic flux passing through the return yoke.

### CROSS-REFERENCE TO RELATED APPLICATION

This application is based upon and claims the benefit of priority of the prior Japanese Laid-open Patent No. 2008-021309, filed on Jan. 31, 2008, the entire contents of which are incorporated herein by reference.

### FIELD

The embodiments discussed herein are related to a magnetic recording device including a magnetic recording medium that rotates and a magnetic head that faces the magnetic recording medium and records information on the magnetic recording medium, and related to a method for generating a clock signal that determines a timing of recording information on the magnetic recording medium.

### BACKGROUND

In recent years, in accordance with improvement in performance of a computer or the like, higher performance such as a higher transmission rate, larger capacity storage has been required for a magnetic recording device typified by a magnetic disk device.

FIG. 12 is a view illustrating a configuration of a conventional magnetic disk device.

In a device housing 11 of a magnetic disk device 10, there are provided a magnetic disk 12, a spindle motor (not illustrated) that rotates the magnetic disk 12 in a direction of an arrow A, a suspension 14 having on its top end a magnetic head 13 that records information on the magnetic disk 12 and reproduces information from the magnetic disk 12, and a VCM 15 that rotates the suspension 14 so that the magnetic head 13 can face a desired position on the magnetic disk 12 in rotation.

Moreover, although illustrated outside the device housing 11 in FIG. 12 for the sake of convenience of illustration, there are provided a preamplifier 21, a read channel 22, an HD controller 23, and a power amplifier 24 in the device housing 11 of the magnetic disk device 10. The preamplifier 21 is mounted on a FPC (Flexible Printed Circuit) provided in the vicinity of the suspension 14. The read channel 22 is mounted on a circuit substrate (not illustrated) provided in the magnetic disk device 10, and controls a recording signal and a reproducing signal. The HD controller 23 controls the entire operation of the magnetic disk device 10 upon reception of a signal or instruction from a host such as an external personal computer (hereinafter referred as “PC”). The power amplifier 24 drives the VCM 15 according to a servo signal from the HD controller 23. The preamplifier 21 is disposed in the vicinity of the magnetic head 13.

For reproducing information recorded on the magnetic disk 12, the information is picked up by the magnetic head 13, a weak signal thus picked up by the magnetic head 13 is amplified by the preamplifier 21, and the amplified signal is transmitted to the read channel 22. In the read channel 22, various types of filters function to extract the signals as a servo signal and a data signal. The information recorded on the magnetic disk 12 has, in a unit region called a sector, a region for a servo signal at the head of the sector, and a region for a data signal follows thereafter.

Positioning of the magnetic head 13 is performed on the basis of a servo signal obtained from the servo signal region. The servo signal demodulated by the read channel 22 is converted by the HD controller 23 into a driving signal that drives the VCM 15 for positioning the magnetic head 13, and the driving signal is transmitted to the power amplifier 24. In the power amplifier 24, the driving signal is converted into a current signal, the current signal is transmitted to the VCM 15 to control rotation of the suspension 14, and thereby the position of the magnetic head 13 on its top end is adjusted.

On the other hand, for recording information on the magnetic disk 12, the magnetic head 13 is first positioned so as to face a target track. Next, a servo signal of a sector where information is to be written is picked up, and thereafter, a recording operation is performed. A write clock, as a base for writing information on the magnetic disk 12, is provided by a crystal oscillator (not illustrated), and the frequency of the write clock signal is converted into an optimal frequency for a track including a sector where information is to be written via a PLL circuit in the read channel 22, thereby a read clock is generated. In the read channel 22, a write signal for writing is generated on the basis of data received from the HD controller 23, the write signal is transmitted to a write amplifier in the preamplifier 21, the transmitted write signal is converted into a current signal to be provided to the magnetic head 13, and the current signal is provided to the magnetic head 13 in synchronization with the write clock. The magnetic head 13 records information on the magnetic disk 12 on the basis of the current signal thus transmitted in synchronization with the write clock. Thus, recording is made in synchronization with the write clock, thereby allowing a stable recording operation.

In recent years, in order to improve recording density and to prevent deterioration in signal quality, a discrete track recording system has been proposed. In the discrete track recording system, a non-magnetic material region is formed between adjacent tracks and recording is performed only on a track section formed by a magnetic material. Moreover, a patterned media recording system has been proposed in which magnetic domain particles are isolated from each other to arrange recording dots, each serving as a recording region for one bit, to thereby improve recording resolution.

Here, in the patterned media recording system, at the moment the writing operation is performed, a recording dot on which information is to be recorded is preferably present just under the magnetic head. In other words, it is important that a clock signal synchronized with the arrangement pattern of recording dots be generated while predicting the position of each recording dot on the magnetic disk medium.

As a technique for generating the clock signal, for example, Japanese Laid-open Patent Publication No. 2003-281701 (Document 1) proposes a magnetic recording device that detects a leakage magnetic field generated in a non-magnetic section when recording is performed, and corrects a phase shift of a clock signal. Moreover, Japanese Laid-open Patent Publication No. 2006-164349 (Document 2) proposes a magnetic recording device that performs recording while shifting a phase of a clock signal to select a phase whose error rate is the lowest.

Since a clock signal synchronized with the arrangement pattern of the magnetic body has to be generated, in the method in which a leakage magnetic field, which is generated in a non-magnetic section when recording is performed, is detected, and a phase shift of a clock signal is corrected as described in, for example, Document 1, there is a problem that the phase shift cannot be corrected when the leakage magnetic field is not correctly detected.

Moreover, the method described in Document 2 has a problem as follows. In general, the recording operation by the magnetic disk device is preferably executed immediately after receiving a recording instruction from a host computer. However, in the method described in Document 2, an optimal amount of phase shift is obtained by performing error rate measurement, and therefore the recording operation cannot be executed immediately after receiving the recording instruction. In order to avoid this problem, an approach is required in which an amount of phase shift measured is stored in the memory in advance, and is reused at the time of operating the device.

However, in many cases, the magnetic disk medium included in the device is clamped, by a frictional force, to a motor hub that rotates the medium, and it happens that the magnetic disk medium rotates against the motor hub due to some impact. Accordingly, the optimal amount of phase shift sometimes changes. It makes it impossible to reuse the amount of phase shift measured and stored in the memory in advance. In addition, it can be considered that the optimal amount of phase shift changes by physical contraction or expansion of the magnetic disk medium due to a change in environmental temperature.

In this case, in the method described in Document 2, the amount of phase shift has to be measured again, thus resulting in a significant reduction in device performance.

Moreover, there is a case in which the frequency of a clock signal deviates from an assumed value due to a change in eccentricity of the magnetic disk medium, an influence of a rotation jitter of a turntable, or the like.

Further, Document 1 and 2 describe the method of detecting a phase shift, but do not describe the method of detecting a frequency shift.

### SUMMARY

A magnetic recording device according to an embodiment of the present invention includes a magnetic recording medium that rotates and a magnetic head that faces the magnetic recording medium and records information on the magnetic recording medium, wherein the magnetic recording medium is a patterned media magnetic recording medium in which a plurality of tracks are arranged for a radial direction in a concentric manner, the tracks each being formed by arranging a plurality of recording dots in a rotational direction, the dots each being made of an isolated magnetic material, and a magnetic head includes a main magnetic pole that faces the magnetic recording medium, a magnetic field generation coil that generates magnetic field to be transmitted to the magnetic recording medium through the main magnetic pole, a return yoke that receives the magnetic flux transmitted to the magnetic recording medium from the main magnetic pole and returns the magnetic flux thus received to the magnetic field generation coil, and a search coil that detects a change in magnetic flux passing through the return yoke.

Objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a view illustrating a configuration of a magnetic disk device that is a first embodiment of a magnetic recording device of the present invention;

FIG. 2 is a view illustrating a configuration of a magnetic head of the magnetic disk device illustrated in FIG. 1 and a configuration of a magnetic disk facing to the magnetic head;

FIGS. 3A to 3E are views illustrating the outline of the manufacturing process of the magnetic head illustrated in FIG. 2;

FIG. 4 is a view illustrating a signal to be detected by a search coil;

FIG. 5 is a circuit diagram illustrating a configuration of a signal detection circuit;

FIG. 6 illustrates signal waveforms that appear in the respective parts of the signal detection circuit illustrated in FIG. 5;

FIG. 7 is a circuit block diagram illustrating a configuration of a clock generation circuit;

FIG. 8 illustrates a relationship between a relative position of a recording dot and the magnetic head, and the level of a signal to be detected by the search coil;

FIG. 9 is a circuit diagram illustrating the signal detection circuit used for searching an optimal position of the magnetic head in radial directions;

FIG. 10 is a view illustrating a configuration of a recording head portion of a magnetic head included in a magnetic disk device according to a second embodiment of the present invention;

FIG. 11 is a view illustrating a configuration of a recording head portion of a magnetic head included in a magnetic disk device according to a third embodiment of the present invention; and

FIG. 12 is a configuration view of a conventional magnetic disk device.

### DESCRIPTION OF EMBODIMENTS

Embodiments of the present invention will be described below.

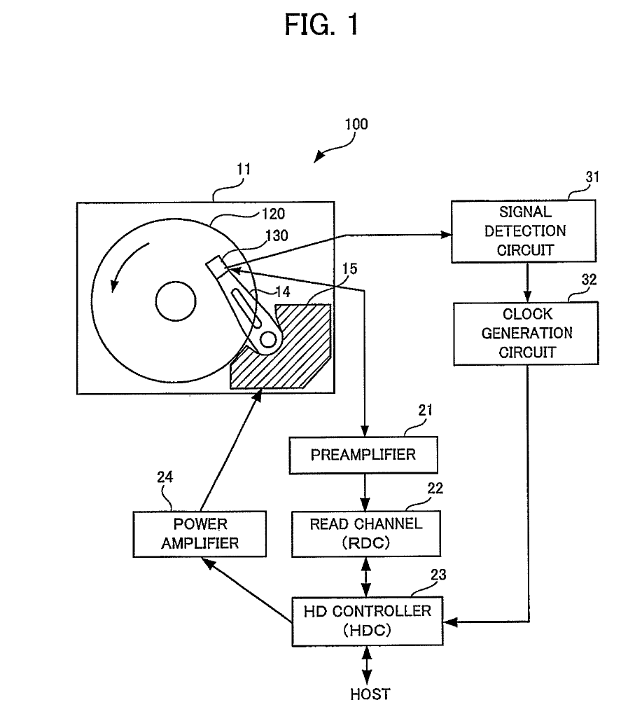

FIG. 1 is a view illustrating a configuration of a magnetic disk device as a first embodiment of a magnetic recording device according to the present invention.

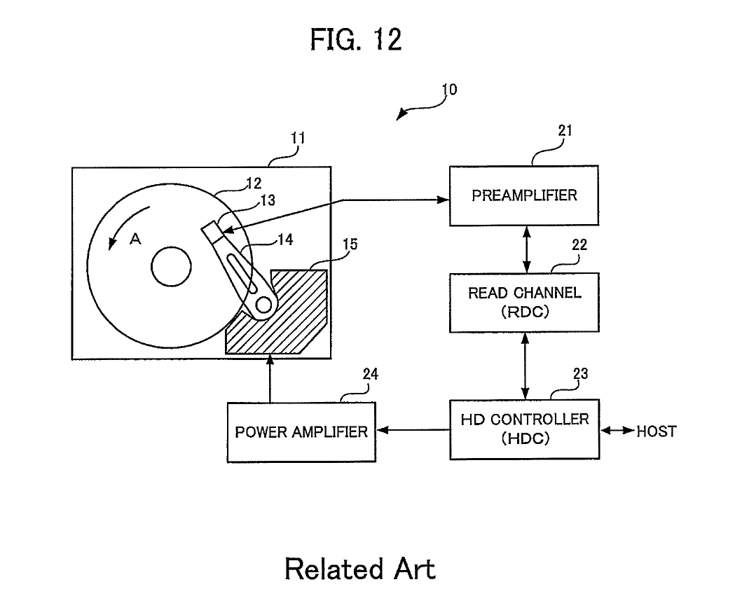

In FIG. 1, the same components as those of the conventional magnetic disk device 10 illustrated in FIG. 12 are given the same reference numerals as those in FIG. 12, and the description will be focused mainly on the difference therebetween.

Regarding the magnetic disk device 10 illustrated in FIG. 12, no particular mention is made of the configuration of the magnetic disk 12. Meanwhile, a magnetic disk 120, which is included in a magnetic disk device 100 illustrated in FIG. 1, is a patterned media magnetic disk. In other words, the magnetic disk 120 illustrated in FIG. 1 has a configuration in which multiple tracks are arranged for radial direction in a concentric manner, the tracks each being formed by arranging multiple recording dots. Each of the recording dots is made of an isolated magnetic material and recording dots are arranged in a rotational direction.

Moreover, the magnetic disk device 100 illustrated in FIG. 1 includes a magnetic head 130 having a different configuration from the magnetic head 13 in the magnetic disk device 10 illustrated in FIG. 12 at a top end of a suspension 14.

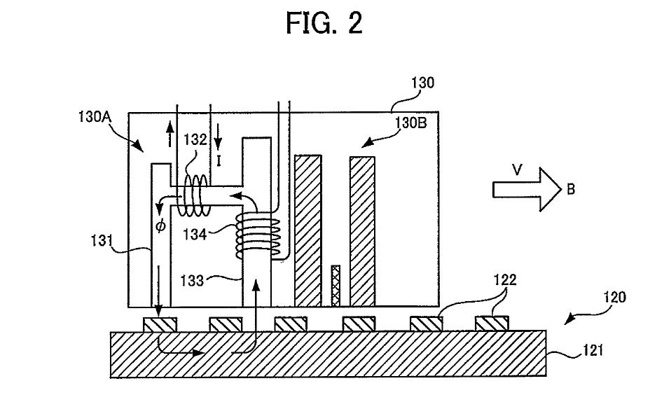

Although the magnetic head 130 is to be described later, the difference between the magnetic head 130 and the magnetic head 13 of the magnetic disk device 10 illustrated in FIG. 12 lies in the point that a search coil 134 (see FIG. 2) is added.

Further, in the magnetic disk device 100 illustrated in FIG. 1, there are provided a signal detection circuit 31 and a clock generation circuit 32, which are circuit elements that are not provided in the magnetic disk device 10 illustrated in FIG. 12. These circuit elements will also be described in detail later.

FIG. 2 is a view illustrating a configuration of the magnetic head 130 included in the magnetic disk device 100 illustrated in FIG. 1 and a configuration of the magnetic disk 120 facing the magnetic head 130.

The magnetic disk 120 has recording dots 122, each made of an isolated island-shaped magnetic material, arranged on a surface of a soft magnetic layer 121. The recording dots 122 are formed by processing a general magnetic recording medium for vertical recording by etching or the like. The width of each recording dot 122 is several tens of nm both in circumferential directions (track directions) of a medium and in radial directions of the medium, and the height thereof is several nm. In order to stabilize a floating characteristic of the magnetic head 130, each space between the recording dots is filled with a non-magnetic material and the surface of the magnetic disk 120 is smoothed by CMP method. Here, the non-magnetic material is formed of a substance having magnetic permeability different from that of the material forming the recording dot, and is formed of silicon dioxide (SiO₂).

The magnetic head 130 moves on the magnetic disk 120 at velocity V in a direction of an arrow B relative to the magnetic disk 120. The velocity V differs depending on the position in the radial directions of the magnetic disk 120 even if the magnetic disk 120 rotates at a constant velocity.

The magnetic head illustrated in FIG. 2 has a structure in which a recording head 130A and a reproducing head 130B are integrally formed. The reproducing head 130B used here is the same as that in the conventional case and the description thereof will be omitted.

The recording head 130A includes a main magnetic pole 131, a magnetic field generation coil 132, a return yoke 133, and the search coil 134.

The magnetic head 130 is attached to a slider using AlTiC as a substrate material, and the magnetic field generation coil 132 and the reproducing head 130B are electrically connected to a preamplifier 21 (see FIG. 1) through interconnections (not illustrated).

The main magnetic pole 131 faces the magnetic disk 120 and transmits a magnetic flux for recording to the magnetic disk 120.

Moreover, the magnetic field generation coil 132 generates a magnetic flux Ø for information recording after a current signal I, from a write amplifier included in the preamplifier 21 illustrated in FIG. 1, flows therethrough. Further, the magnetic field generation coil 132 also serves to generate a bias magnetic flux Ø upon reception of a DC or AC bias current from the write amplifier. A detailed description will be given later.

Further, the recording head 130A includes the return yoke 133. The return yoke 133 serves to return the magnetic flux Ø, which is transmitted to the magnetic disk 120 from the main magnetic pole 131, to the magnetic field generation coil 132 upon reception thereof.

Furthermore, the recording head 130A includes the search coil 134 wound round the return yoke 133. The search coil 134 is formed by a general magnetic coil manufacturing process using copper as a material. The search coil 134 serves to pick up the magnetic flux returned to the magnetic field generation coil 132 through the return yoke 133 when the bias current flows into the magnetic field generation coil 132 and the bias magnetic flux Ø flows through the main magnetic pole 131. When the magnetic head 130 moves relative to the magnetic disk 120 at velocity V in the direction of the arrow B, the main magnetic pole 131 passes a position facing the recording dot 122 and a position deviating from the recording dot 122, alternately. Since a characteristic as a magnetic material is different between a portion where the recording dot is present and a portion where no recording dot is present, there is a difference in a magnetic resistance value therebetween when seen as the magnetic circuit. Accordingly, magnetic flux density in the return yoke 133 changes, and therefore the change is detected by the search coil 134.

Here, if the number of windings of the search coil 134 is increased, it is possible to observe a larger change in magnetic flux density to be detected by the search coil 134.

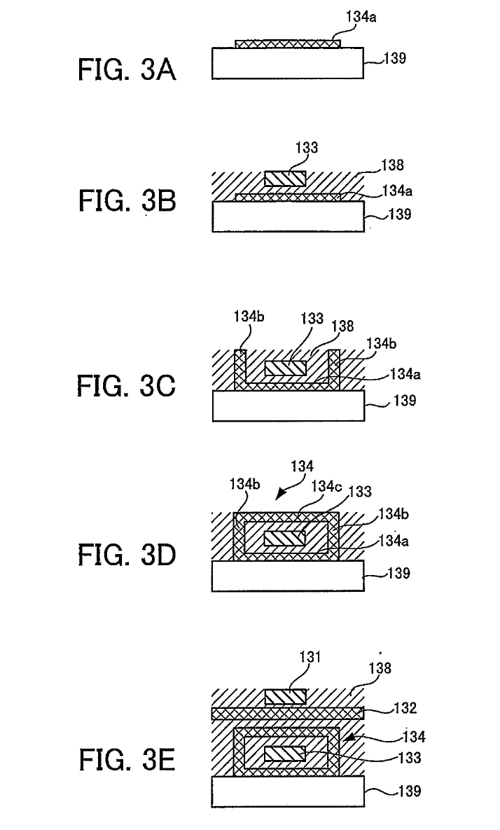

FIGS. 3A to 3E are views illustrating the outline of the manufacturing process of the magnetic head 130 illustrated in FIG. 2.

In each of FIGS. 3A to 3E, an upper portion indicates a main magnetic pole side and a lower portion indicates a reproducing head side. Here, the reproducing head is assumed to be already formed by the same manufacturing process as that used in the conventional case, and the recording head manufacturing process will be described.

First, as illustrated in FIG. 3A, a portion 134a of the search coil 134 illustrated in FIG. 2 is formed on a shield film 139 that shields between the reproducing head and the recording head, and the return yoke 133 is formed thereon so as to be buried in a low expansion filler 138 (FIG. 3B). Further, a portion 134b of the search coil 134 is formed so as to be buried in the low expansion filler 138 (FIG. 3C), and a residual portion 134c of the search coil 134 is formed to thereby complete the search coil 134 (FIG. 3D). Furthermore, the magnetic field generation coil 132 is formed thereon so as to be buried in the low expansion filler 138, and the main magnetic pole 131 is formed thereon (FIG. 3E).

Although the magnetic head of the present embodiment is different from the conventional magnetic head in the point that the search coil 134 is added thereto, the search coil 134 can be manufactured by the general process as described above.

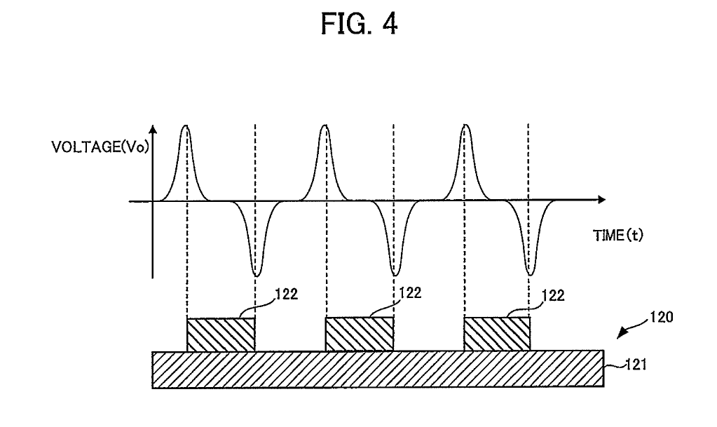

FIG. 4 is a view illustrating a signal to be detected by the search coil 134.

If the magnetic head 130 having the configuration illustrated in FIG. 2 moves relative to and facing the magnetic disk 120, an electromotive force having a waveform as illustrated in FIG. 4 appears in the search coil 134. This is because the magnetic resistance value differs between regions on the magnetic disk 120 where the recording dot 122 is present and where no recording dot 122 is present, and the change in the magnetic flux appears at the end portions of the recording dot 122. The signal having the waveform as illustrated in FIG. 4 appeared in the search coil 134 is input to the signal detection circuit 31 (see FIG. 1).

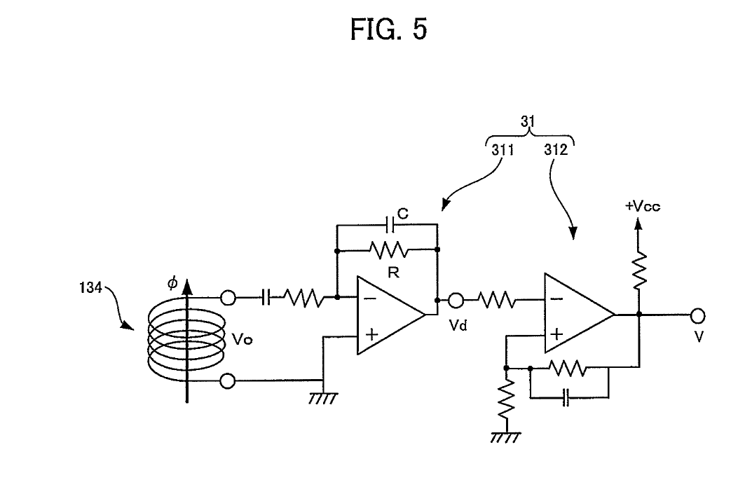

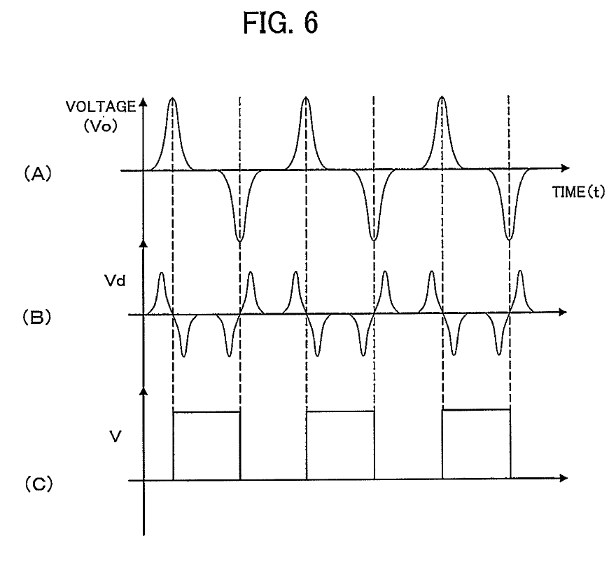

FIG. 5 is a circuit diagram illustrating a configuration of the signal detection circuit 31, and FIG. 6 illustrates signal waveforms that appear in the respective parts of the signal detection circuit 31 illustrated in FIG. 5.

In Parts (A) to (C) of FIG. 6, a signal Vo to be detected by the search coil 134, an output signal Vd of a differentiating circuit 311, and an output signal V of a comparator 312 are illustrated in order from the top.

When the magnetic flux Ø passing through the search coil 134 changes, the electromotive force Vo represented by Vo=−N(dØ/dt), (where N is the number of windings of the search coil), is generated (see FIG. 4 and Part (A) OF FIG. 6). The electromotive force Vo is inputted to the differentiating circuit 311 included in the signal detection circuit 31 to perform a differential arithmetic operation and thereby the differential waveform signal Vd, which has a zero crossing at each edge portion of the recording dot 122 (see FIG. 4) as illustrated in Part (B) OF FIG. 6, is generated. Further, the differential waveform signal Vd is inputted to the comparator 312 by which each zero-crossing point is detected, and the detected zero-crossing points are converted into the pulse signals V as illustrated in Part (C) OF FIG. 6. The pulse signals V are inputted to the clock generation circuit 32 (see FIG. 1), and the clock generation circuit 32 generates a clock signal on the basis of the pulse signals V.

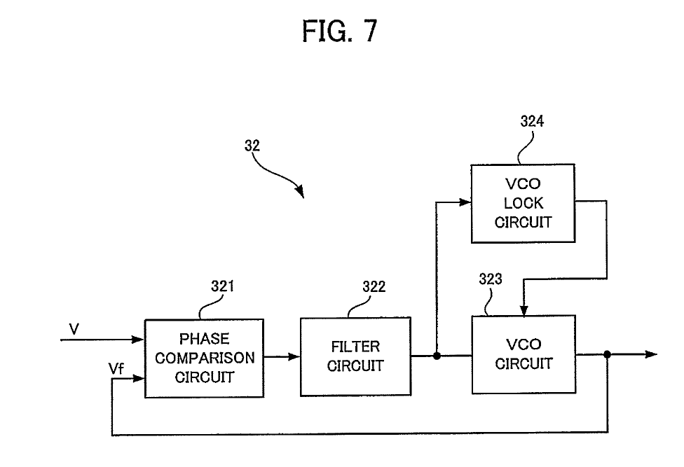

FIG. 7 is a circuit block diagram illustrating a configuration of the clock generation circuit 32.

The clock generation circuit 32 illustrated in FIG. 7 is called a PLL circuit. A phase comparison circuit 321 performs phase comparison between the pulse signal V inputted to the clock generation circuit 32 and a feedback signal Vf being an output signal of the clock generation circuit 32. When the two input signals V and Vf have an equal frequency and their phases are shifted by 90 degrees with each other, the phase comparison circuit 321 outputs a signal from which a DC component is removed, and when the phases are shifted by degrees other than 90 degrees, the phase comparison circuit 321 outputs a signal having a DC offset voltage component corresponding to an amount of the shift from 90 degrees. The output of the phase comparison circuit 321 is inputted to a filter circuit 322 by which a high frequency component is removed therefrom and a phase difference between the two signals V and Vf is outputted as a DC error signal. The DC error signal outputted from the filter circuit 322 is inputted to a VCO circuit 323 and a VCO lock circuit 324. The VCO circuit 323 is an oscillator that generates a pulse signal having a frequency which varies according to a change in DC error signal inputted from the filter circuit 322. The VCO lock circuit 324 detects that the DC error signal, being an output signal from the filter circuit 322, lies within a predetermined range and fixes an oscillation frequency of the VCO circuit 323.

Thus, the clock generation circuit 32 generates a clock signal synchronized with a recording dot cycle.

The clock signal thus generated by the clock generation circuit 32 is inputted to an HD controller 23 as a write clock signal.

In the magnetic disk device 100 illustrated in FIG. 1, a recording operation is performed as follows by using the thus generated write clock signal.

(1) First, the magnetic disk device 100 receives a recording instruction from a host such as a PC or the like.

(2) The HD controller 23 performs control to move the magnetic head 130 to a target track.

(3) A read channel 22 reads servo information and confirms that the magnetic head 130 reaches a target track and a target sector.

(4) The read channel 22 generates a pulse signal to be written in the magnetic disk 120 according to a write instruction obtained from the HD controller 23.

(5) After searching a servo signal region by the magnetic head 130, a bias magnetic field is applied from the magnetic field generation coil 132.

(6) The search coil 134 detects a signal synchronized with a recording bit, a write clock signal is generated by the signal detection circuit 31 and the clock generation circuit 32, and the write clock signal is transmitted to the read channel 22 via the HD controller 23.

(7) The read channel 22 takes a write signal at a timing synchronized with the write clock signal for the preamplifier 21, and the preamplifier 21 converts the write signal into a head drive current signal.

(8) The head drive current signal is transmitted to the magnetic field generation coil 132 of the recording head to perform a recording operation.

As a format of a recording region for the magnetic disk 120, a region for generating a write clock signal is formed at the top of data, and this region is followed by a region for generating a preamble signal for a reproduction signal, and then followed by a region for generating a data signal.

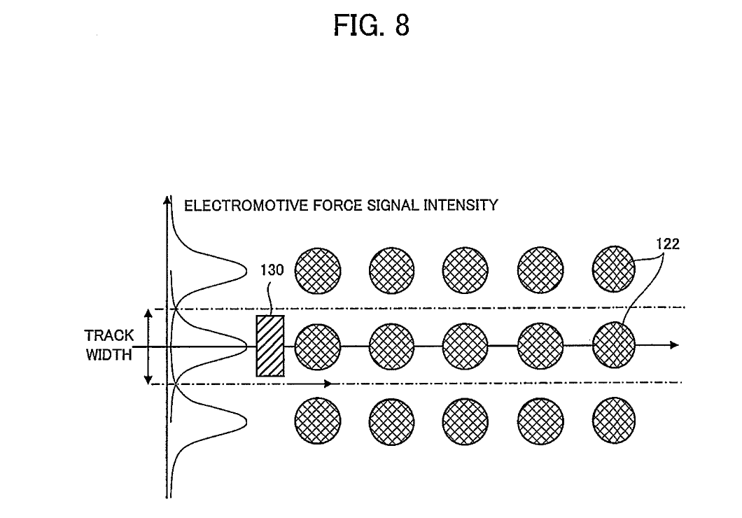

FIG. 8 illustrates a relationship between the relative position of a recording dot and a magnetic head, and a level of a signal detected by the search coil.

When the magnetic head 130 is placed at the center of the track, a change in presence or absence of the recording dot 122 appears as a signal having a high level in the search coil 134. On the other hand, when the magnetic head 130 deviates from the center of the track and is placed at a position close to an adjacent track, this appears as a signal having a low level in the search coil 134.

Accordingly, after the magnetic head 130 is moved to the target track, the magnetic head 130 is driven so as to move in the radial directions in the target track (upper and lower directions in FIG. 8) to thereby detect a position at which the largest change in magnetic flux, which is to be detected by the search coil 134, appears (maximum position). Then, at the time of recording data on the magnetic disk, the position of the magnetic head in the radial directions is adjusted to a position corresponding to the detected maximum position of the change in magnetic flux. This makes it possible to move the magnetic head 130 to an optimal position in the radial directions.

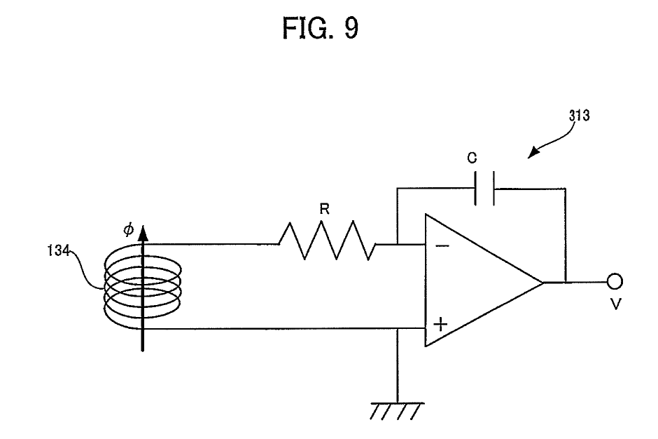

FIG. 9 is a circuit diagram illustrating a signal detection circuit used for searching an optimal position of the magnetic head in the radial directions.

As a detection circuit for searching the optimal position of the magnetic head in the radial directions, there is used an integrating circuit 313 for obtaining a largest value of the electromotive force obtained by the search coil 134, unlike the detection circuit for clock generation (see FIG. 5).

The signal detection circuit illustrated in FIG. 9 is also disposed in the signal detection circuit 31 illustrated in FIG. 1, and the output signal is inputted to the HD controller 23 passing through the clock generation circuit 32. At the time of searching, the HD controller 23 causes the magnetic head 130 to perform searching while moving it in the radial directions in the target track. After the searching, the HD controller 23 performs control to adjust the position of the magnetic head 130 in the radial directions such that the magnetic head 130 may be positioned at the center of the target track.

With the above, the description of the first embodiment of the present invention is ended, and another embodiment will be described below. A difference between the embodiment to be described below and the first embodiment lies in only the configuration of the magnetic head, in particular, only the recording head portion of the magnetic head. Thus, only the configuration of the recording head will be described below.

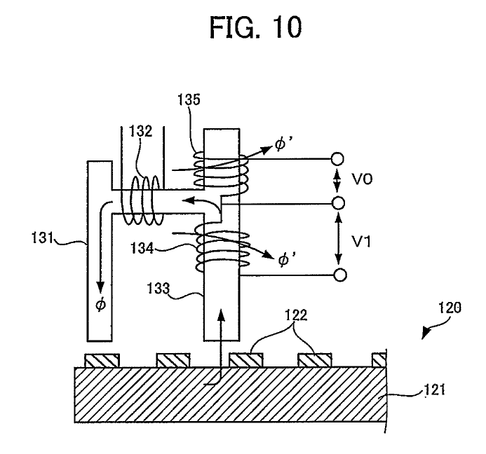

FIG. 10 is a view illustrating a configuration of the recording head portion of the magnetic head included in a magnetic disk device according to a second embodiment of the present invention. In FIG. 10, the same components as those of the recording head 130A (see FIG. 2) in the first embodiment are given the same reference numerals as those in FIG. 2, and the description will be focused mainly on the difference therebetween.

In the case of attaching the search coil 134 to the return yoke 133, at the time of applying a bias magnetic field from the magnetic field generation coil 132, leakage magnetic flux Ø′ therefrom becomes noise. For example, even when a DC bias is applied as the bias magnetic field, an AC modulated magnetic field is slightly generated since there is an AC noise component included in a DC current. This affects the search coil to cause noise.

In the configuration of the magnetic head illustrated in FIG. 10, a return yoke 133 is provided with: a search coil 134 disposed in a magnetic circuit formed by a magnetic field generation coil 132, a magnetic disk 120, and the return yoke 133; and a disturbance correction coil 135 on the return yoke 133 disposed at a portion deviated from the magnetic circuit. In the disturbance compensation coil 135 disposed at the portion deviated from the magnetic circuit, a signal, which is affected by the AC modulated leakage magnetic flux Ø′ generated in the magnetic field generation coil 132, is detected. On the other hand, the search coil 134 disposed in the magnetic circuit detects a signal generated by the electromotive force according to the change in magnetic flux of the return yoke 133. The AC modulated leakage magnetic flux Ø′ generated by the magnetic field generation coil 132 is also included in the search coil 134 at the same time.

The search coil 134 and the disturbance compensation coil 135 are disposed at positions which are magnetically symmetrical with respect to the magnetic field generation coil 132, and are equally affected by the AC modulated leakage magnetic flux Ø′, so that noise signals to be generated therefrom are at the same level. Here, by making the coil winding directions of the search coil 134 and the disturbance compensation coil 135 reversed to each other and connecting the both coils to each other, the AC modulated magnetic field signals generated in the both coils are cancelled. Thereby, it is possible to obtain a recording bit position detection signal having a good SN ratio.

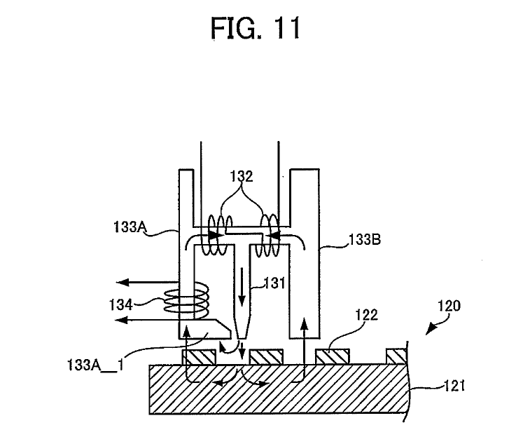

FIG. 11 is a view illustrating a configuration of a recording head portion of a magnetic head included in a magnetic disk device according to a third embodiment of the present invention. Similar to the case of the second embodiment (FIG. 10), in FIG. 11, the same components as those of the recording head 130A in the first embodiment (see FIG. 2) are given the same reference numerals as those in FIG. 2, and the description will be focused mainly on the difference therebetween.

The recording head illustrated in FIG. 11 is not a single-pole recording head having described so far but a double-coil recording head. In this case, the double-coil recording head includes a main magnetic pole 131 formed at the center thereof and two return yokes 133A and 133B facing each other with the main magnetic pole 131 interposed therebetween. In the return yoke 133A of the two return yokes 133A and 133B, there is formed a trailing shield 133A_1 extending in a direction coming close to the top end of the main magnetic pole 131.

In the case of the double-coil recording head, magnetic field generation coils 132 are disposed so as to face each other while being divided into two with the main magnetic pole 131 as the center. This provides an advantage that leaked magnetic fields generated by the respective divided portions are canceled and generation of an unnecessary magnetic field signal is thereby prevented.

In the case of the double-coil magnetic head instead of the single-pole magnetic head, the return yoke is divided, and therefore it is difficult to detect a change in magnetic flux. For this reason, FIG. 11 illustrates the example in which the search coil is attached on the trailing shield side.

More specifically, regarding the magnetic circuit formed by the magnetic field generation coil 132 and a magnetic disk 120, since the return yoke is divided into two, a search coil 134 is attached to either one of the return yokes to detect the change in magnetic flux at recording dots 122 on the surface of the magnetic disk 120. Here, an advantageous arrangement is achieved by providing the search coil 134 at the yoke having the trailing shield 133A_1 on which the magnetic flux more concentrates.

In this case, when manufacturing the magnetic head, the search coil 134 is formed after the magnetic field generation coil 132 is formed. However, no particular trouble occurs in the process by the foregoing coil forming manner.

As has been described thus far, according to the above embodiments, it is possible to accurately generate a write clock signal synchronized with a recording dot position on the magnetic disk in the patterned media recording.

The configuration of the magnetic disk device is characterized by providing a search coil, which detects a change in magnetic flux, on a return yoke inside a recording head. An increase in the number of windings of the search coil enables to detect an electromotive force representing a change in magnetic flux in a significant manner.

In the second embodiment, to deal with the influence of the leakage magnetic field from the magnetic field generation coil, a configuration is employed in which the search coil and the disturbance compensation coil are disposed at positions which are magnetically symmetrical with respect to the magnetic field generation coil. In this configuration, the search coil is disposed in the magnetic circuit formed by the magnetic field generation coil and the magnetic disk, and the disturbance compensation coil is disposed outside the magnetic circuit. By making the wire winding directions of the coils reversed to each other and connecting the both coils to each other, it is possible to cancel a noise component due to the leakage magnetic field from the magnetic field generation coil, thereby to obtain a recording bit position signal having a high signal quality, and to produce a write clock signal accurately.

In the case of the third embodiment in which the double-coil recording head is included, the return yoke is divided. However, the search coil is provided on the trailing shield side where magnetic flux more concentrates to thereby obtain a good signal.

Further, in each embodiment, scanning is performed in the radial directions of the track while magnitude of the electromotive force signal due to the change in magnetic flux is being measured. Thereby, the recording head can be moved to a position where the electromotive force signal is maximized, thus improving stabilization of the recording operation.

The magnetic recording device according to any of the above-described embodiments includes the search coil, and therefore it is possible to detect a change in magnetic characteristic of the magnetic recording medium. The change in magnetic characteristic mentioned here represents a change in magnetic flux density to be generated in a magnetic circuit formed by the magnetic field generation coil, the main magnetic pole, the magnetic recording medium, and the return yoke. In other words, there is a difference in characteristic as a magnetic material between a portion where the recording dot is present and a portion where no recording dot is present, and therefore there is a difference in magnetic resistance value therebetween when seen as the magnetic circuit. Accordingly, the magnetic flux density in the return yoke changes, and therefore it is possible to detect the change by the search coil.

As has been described thus far, according to the present invention, the change in magnetic flux density that changes according to the arrangement of the recording dots can be detected by the search coil, thereby making it possible to perform data writing in synchronization with the arrangement of the recording dots.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic recording device comprising:
a magnetic recording medium that rotates; and
a magnetic head that faces the magnetic recording medium and records information on the magnetic recording medium,
wherein the magnetic recording medium is a patterned media magnetic recording medium in which a plurality of tracks are arranged for a radial direction in a concentric manner, the tracks each being formed by arranging a plurality of recording dots in a rotational direction, the dots each being made of an isolated magnetic material, and
the magnetic head includes:
a main magnetic pole that faces the magnetic recording medium,
a magnetic field generation coil that generates magnetic field to be transmitted to the magnetic recording medium through the main magnetic pole,
a return yoke that receives the magnetic flux transmitted to the magnetic recording medium from the main magnetic pole and returns the magnetic flux thus received to the magnetic field generation coil, and
a search coil that detects a change in magnetic flux passing through the return yoke.

2. The magnetic recording device according to claim 1, wherein the magnetic head further includes a disturbance compensation coil that cancels, upon reception of leakage magnetic flux from the magnetic field generation coil, an influence of leakage magnetic flux that the search coil receives from the magnetic field generation coil.

3. The magnetic recording device according to claim 2, wherein the disturbance compensation coil is directly connected to the search coil in a direction to cancel the leakage magnetic flux that the search coil receives.

4. The magnetic recording device according to claim 1, wherein the magnetic head includes two return yokes facing each other with the main magnetic pole interposed therebetween,
one of the two return yokes has a trailing shield extending in a direction coming close to a tip of the main magnetic pole, and
the search coil is formed at a position where magnetic flux, passing through the one of two return yokes having the trailing shield, is detected.

5. The magnetic recording device according to claim 2, wherein the magnetic head includes two return yokes facing each other with the main magnetic pole interposed therebetween,
one of the two return yokes has a trailing shield extending in a direction coming close to a tip of the main magnetic pole, and
the search coil is formed at a position where magnetic flux, passing through the one of two return yokes having the trailing shield, is detected.

6. The magnetic recording device according to claim 3, wherein the magnetic head includes two return yokes facing each other with the main magnetic pole interposed therebetween,
one of the two return yokes has a trailing shield extending in a direction coming close to a tip of the main magnetic pole, and
the search coil is formed at a position where magnetic flux, passing through the one of two return yokes having the trailing shield, is detected.

7. The magnetic recording device according to claim 1, wherein the magnetic head further includes a clock generation circuit that catches a change in magnetic flux, which is caused by rotation of the magnetic recording medium and detected by the search coil, and that generates a clock signal having a cycle corresponding to a cycle of the recording dots arranged on the magnetic recording medium.

8. The magnetic recording device according to claim 2, wherein the magnetic head further includes a clock generation circuit that catches a change in magnetic flux, which is caused by rotation of the magnetic recording medium and detected by the search coil, and that generates a clock signal having a cycle corresponding to a cycle of the recording dots arranged on the magnetic recording medium.

9. The magnetic recording device according to claim 3, wherein the magnetic head further includes a clock generation circuit that catches a change in magnetic flux, which is caused by rotation of the magnetic recording medium and detected by the search coil, and that generates a clock signal having a cycle corresponding to a cycle of the recording dots arranged on the magnetic recording medium.

10. The magnetic recording device according to claim 1, further comprising:
a drive circuit that drives the magnetic head so as to move the magnetic head in the radial directions in the same track; and
a peak position detection circuit that detects a position where the largest change in magnetic flux occurs, the change in magnetic flux being detected by the search coil, when the magnetic head moves in the radial directions in the same track,
wherein the drive circuit adjusts the position of the magnetic head in the radial directions to a position corresponding to the position where the largest change in magnetic flux occurs, which is detected by the peak position detection circuit, at the time of recording information on the magnetic recording medium.

11. The magnetic recording device according to claim 2, further comprising:
a drive circuit that drives the magnetic head so as to move the magnetic head in the radial directions in the same track; and
a peak position detection circuit that detects a position where the largest change in magnetic flux occurs, the change in magnetic flux being detected by the search coil, when the magnetic head moves in the radial directions in the same track,
wherein the drive circuit adjusts the position of the magnetic head in the radial directions to a position corresponding to the position where the largest change in magnetic flux occurs, which is detected by the peak position detection circuit, at the time of recording information on the magnetic recording medium.

12. The magnetic recording device according to claim 3, further comprising:
a drive circuit that drives the magnetic head so as to move the magnetic head in the radial directions in the same track; and
a peak position detection circuit that detects a position where the largest change in magnetic flux occurs, the change in magnetic flux being detected by the search coil, when the magnetic head moves in the radial directions in the same track,
wherein the drive circuit adjusts the position of the magnetic head in the radial directions to a position corresponding to the position where the largest change in magnetic flux occurs, which is detected by the peak position detection circuit, at the time of recording information on the magnetic recording medium.

13. A method of generating a clock signal that determines a timing of recording information on a plurality of recording dots in a magnetic recording device, the magnetic recording device including: a magnetic recording medium that rotates; and a magnetic head that faces the magnetic recording medium and records information on the magnetic recording medium, in which the magnetic recording medium is a patterned media magnetic recording medium where a plurality of tracks are arranged for radial direction in a concentric manner, the tracks each being formed by arranging the recording dots in a rotational direction, each of the recording dots being made of an isolated magnetic material, and the magnetic head includes: a main magnetic pole that faces the magnetic recording medium, a magnetic field generation coil that generates magnetic flux to be transmitted to the magnetic recording medium through the main magnetic pole, a return yoke that receives the magnetic flux transmitted to the magnetic recording medium from the main magnetic pole and returns the magnetic flux thus received to the magnetic field generation coil, and a search coil that detects a change in magnetic flux passing through the return yoke, the method comprising:
detecting a change in magnetic flux passing through the return yoke by the search coil while rotating the magnetic recording medium; and
catching the change in magnetic flux detected by the search coil and generating a clock signal having a cycle corresponding to a cycle of the recording dots arranged on the magnetic recording medium.
